(19) United States
(12) Patent Application Publication
(10) Pub. No.: US 2013/0071823 A1
(43) Pub. Date: Mar. 21, 2013

(54) EXERCISE LEARNING SYSTEM AND A METHOD FOR ASSISTING THE USER IN EXERCISE LEARNING

(71) Applicants: Chung-Wei Lin, Changhua City (TW); Chih-Yuan Liu, Zhubei City (TW); Lun-Chia Kuo, Taichung City (TW); Kun-Chi Feng, New Taipei City (TW)

(72) Inventors: Chung-Wei Lin, Changhua City (TW); Chih-Yuan Liu, Zhubei City (TW); Lun-Chia Kuo, Taichung City (TW); Kun-Chi Feng, New Taipei City (TW)

(73) Assignee: INDUSTRIAL TECHNOLOGY RESEARCH INSTITUTE, HSINCHU (TW)

(21) Appl. No.: 13/343,556

(22) Filed: Jan. 4, 2012

(30) Foreign Application Priority Data
Sep. 21, 2011 (TW) 100134028

(51) Int. Cl. G09B 19/00

(52) U.S. Cl. 434/247

(57) ABSTRACT

An exercise learning system including a sensing unit and a processing module is disclosed. The sensing unit includes at least one sensor used for being disposed on the body of a user. Each sensor further outputs a sensing data according to the exercise state of the user. The processing module generates at least one critical action data of the user according to the at least one sensing data. The processing module further synchronizes and compares the at least one critical action data with the corresponding at least one pre-produced action data.

This application claims the benefit of Taiwan application Serial No. 100134028, filed Sep. 21, 2011, the disclosure of which is incorporated by reference herein in its entirety.

### BACKGROUND

1. Technical Field

The disclosed embodiments relate in general to a learning system and a method for assisting the user in learning, and more particularly to an exercise learning system and a method for assisting the user in exercise learning.

2. Description of the Related Art

In recent years, a “333” principle was advocated by Taiwanese government with an aim to improving people's health. The “333” principle suggests that people should do exercises 3 times a week, each time the exercise should last for 30 minutes and achieves 130 heart beats per minute. However, the statistics shows that only 25% of people do exercise regularly. If a system for assisting the user in exercise learning can be provided to help the user do exercise more correctly, the user would be more willing to do exercise, and people's health can thus be improved nationwide. Therefore, how to provide a system for assisting the user in exercise learning has become a prominent task for the industries.

### SUMMARY

The disclosure is directed to an exercise learning system and a method for assisting the user in exercise learning for enabling the user to learn how to exercise correctly and achieve excellent learning results.

According to one embodiment, an exercise learning system including a sensing unit and a processing module is disclosed. The sensing unit includes at least one sensor used for being disposed on the body of a user. Each sensor further outputs a sensing data according to the exercise state of the user. The processing module generates at least one critical action data of the user according to the at least one sensing data. The processing module further synchronizes and compares the at least one critical action data with the corresponding at least one pre-produced action data

According to another embodiment, a method for assisting the user in exercise learning is disclosed. The method includes the following steps. At least one sensor disposed on the body of a user is provided, wherein each sensor outputs a sensing data according to the exercise state of the user. At least one critical action data of the user is generated according to the at least one sensing data. The at least one critical action data and the corresponding at least one pre-produced action data are synchronized and compared with each other.

### BRIEF DESCRIPTION OF THE DRAWINGS

FIG. 1 shows a block diagram of an exercise learning system according to an embodiment of the disclosure;

FIG. 2 shows an example of the proportion of body;

FIG. 3 shows an example of a method for calculating an initial position of an exercise sensor in the space;

FIG. 4 shows an example of the experimental results of corresponding position in the space, corresponding velocity and corresponding acceleration of gravity for each critical action in the course of a swing action in Golf;

FIG. 5A and FIG. 5B respectively show an example of the replay of an erroneous action frame;

FIG. 6 shows a flowchart of a method for assisting the user in exercise learning.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

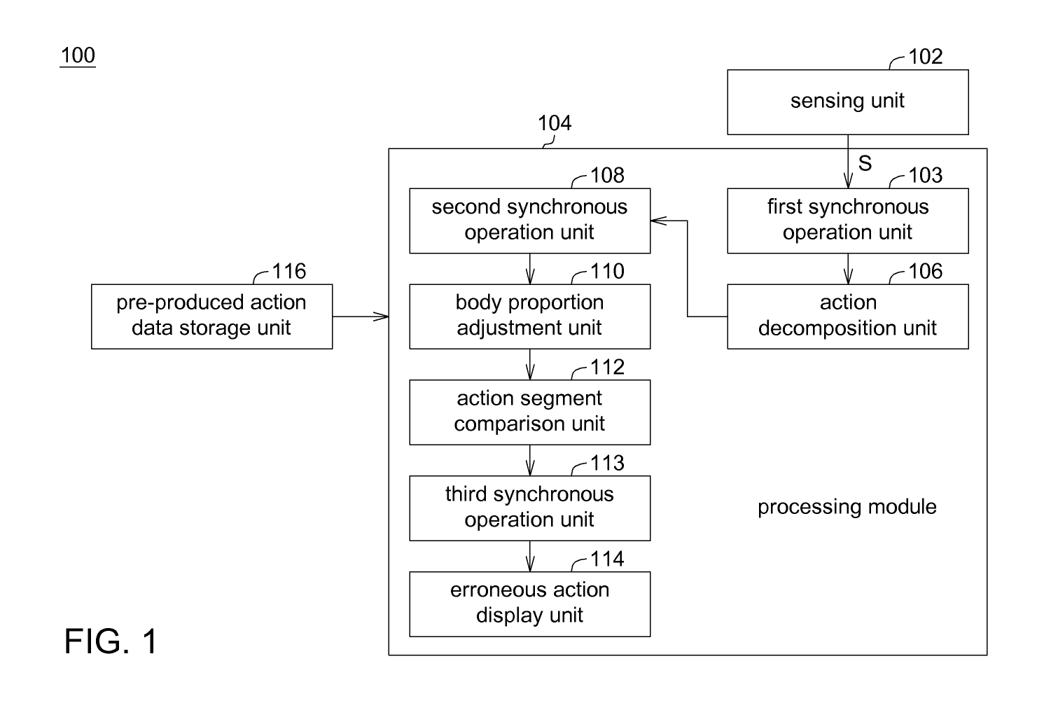

Referring to FIG. 1, a block diagram of an exercise learning system according to an embodiment of the disclosure is shown. The exercise learning system 100 includes a sensing unit 102, a pre-produced action data storage unit 116, and a processing module 104. The sensing unit 102 includes at least one sensor used for being disposed on the body of a user. Each sensor further outputs a sensing data S according to the exercise state of the user. The processing module 104 generates at least one critical action data of the user according to the at least one sensing data S. The processing module 104 further synchronizes and compares the at least one critical action data with the corresponding at least one pre-produced action data.

The sensors such as include an acceleration sensor, a gravity sensor, an angular velocity meter, a magnetometer, or a pressure gauge. The sensors can be realized by other types of sensors. The sensors are such as disposed on the user's shoulders, wrists, waists, knees, and/or ankles.

The pre-produced action data corresponds to a coach's demonstration or a learner's own previous exercise action. That is, the pre-produced action data is correlated with the coach's exercise action image and exercise sensing data, or is correlated with the learner's own previous exercise action image and exercise sensing data. An example of the generation of the pre-produced action data is exemplified below. A teaching film of the coach's exercise action image is obtained by recording the coach's demonstration for a particular exercise with a video recorder. During the recording process, the coach's exercise sensing data corresponding to the exercise state of each part of the coach's body is recorded (with the use of several sensors for example). The coach's exercise action image and exercise sensing data are synchronized first, and then the coach's critical action data is pre-determined from the coach's exercise sensing data. The relationship between the coach's exercise action image and the coach's exercise sensing data is recorded in a mapping table in which the time points of the occurrences of critical actions as well as the sensor reading, the velocity and the position of exercise trace that are obtained through calculation are recorded. The time format is hh:mm:ss:ms (hour:minute:second:millisecond). The sensor reading includes the acceleration of gravity, the angular velocity, the directional angle of exercise, and so on. The mapping table can be an independent electronic file. The coach's exercise action image and exercise sensing data can be recorded as different files. The coach's exercise sensing data can be recorded in the data column of a video file of the coach's exercise action image at the same time. A specific player is used for reading the sensing data stored in the data column of the video file.

Besides, in order to synchronize the coach's exercise action image and the coach's exercise sensing data, after the video film and the sensing data (including critical action, the sensor reading and the exercise trace) are obtained, the corresponding recording tick values, such as Tsᵢ and Tcᵢ, should be converted to the same timeline according to the difference in the sampling rate such as Psᵢ and Pcᵢ. The conversion formula is expressed as follows:

Tsᵢ′=(Tsᵢ−Ts₁)/Psᵢ

Tcᵢ′=(Tcᵢ−Tc₁)/Pcᵢ

If the tick value (Tc₁) is 52642 when the sensor reads the first sensing data, then the tick value (Tc₂) of the second sensing data is 52644, the sampling rate per second (Pcᵢ) is 120 times, and the then-recorded tick values (Tc₁′ and Tc₂′) are 0 and 0.016 respectively.

Likewise, suppose the tick value (Ts₁) of the first frame of the video file is 5236, then the tick value (Ts₂) of the second frame is 5238, the frame rate per second is 60, and the then-recorded tick values (Ts₁′ and Ts₂′) are 0 and 0.033.

When the user would like to learn the action of a particular exercise, the user can wear several sensors, watch the teaching film and imitate the coach's action accordingly. During the imitation, the several sensors disposed on the user will generate the sensing data of different parts of the user's body when the user is doing exercise. The sensing data is such as the acceleration values of different parts of the body when the user is doing exercise. The processing module 104 generates the user's several critical action data according to the sensing data S, and further synchronizes and compares the several critical action data of the user learning the action of a particular exercise with the corresponding coach's several pre-produced action data so as to obtain the similarity between the user's imitation and the coach's standard action.

If the similarity is smaller than a threshold, then the processing module 104 determines that this is a critical action with larger deviation, replays the segment of the coach's teaching film corresponding to the critical action with larger deviation for the user to watch and imitate the coach's action again. Thus, the user would be able to understand which action is more deviated from the coach's standard action and needs to be adjusted. By replaying the actions that need to be adjusted for the user to watch again and again, the user would quickly pick up the action of the particular exercise.

Furthermore, the processing module 104 may further include an action decomposition unit 106, a first synchronous operation unit 103, a second synchronous operation unit 108, a body proportion adjustment unit 110, an action segment comparison unit 112, a third synchronous operation unit 113 and an erroneous action display unit 114. The action decomposition unit 106 generates an exercise trace corresponding to the exercise state of the user according to the at least one sensing data S, and decomposes the exercise trace to generate at least one critical action data. The action decomposition unit 106 such as decomposes the exercise trace according to the definition of the critical action.

The second synchronous operation unit 108 synchronizes and compares the sensing data of the at least one critical action with the sensing data of the corresponding at least one pre-produced action. The body proportion adjustment unit 110 adjusts at least one of the at least one critical action data and at least one pre-produced action data according to the difference between the user's body builds and the coach's body builds. The action segment comparison unit 112 compares the similarity between the at least one critical action data and the corresponding pre-produced action data. The erroneous action display unit 114 replays a teaching film corresponding to the pre-produced action data when the similarity between one of the at least one critical action data and the corresponding pre-produced action data is smaller than a threshold.

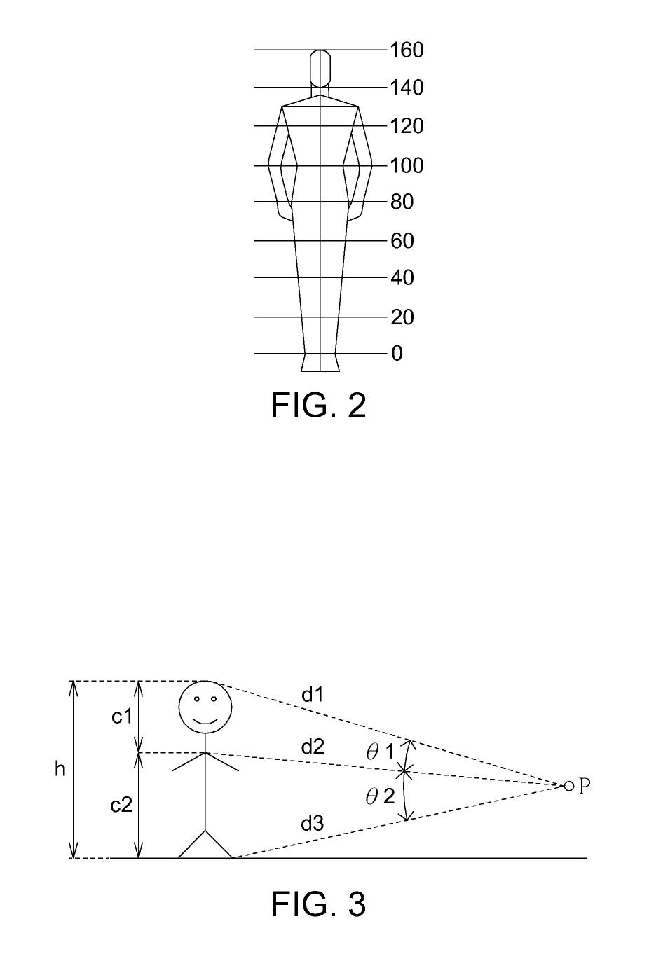

Firstly, the positions of several sensors are initialized and the several sensors are synchronized. Let the front of the user be defined as the positive X-axis, the left of the user be defined as the positive Y-axis and the above of the user be defined as the positive Z-axis. The user can inform the exercise learning system 100 of the user's height via an input device such as a keyboard, a mouse, or a wireless pointing device. Based on the data of the user's height, the exercise learning system 100 obtains the proportions of limbs according to the standard proportions of body limbs or the proportions of the user's limbs to estimate the initial position of each exercise sensor in the space. Referring to FIG. 2. Suppose the user's height is 160 cm, the initial positions of the exercise sensors disposed on the user's shoulders are (0, 15, 130) and (0, −15, 130), the initial positions of the exercise sensors disposed on the wrist are (0, 15, 80) and (0, −15, 80), the initial position of the exercise sensor disposed on the waist is (10, 0, 100), and the initial positions of the exercise sensor disposed on the two knees are (5, 5, 40) and (5, −5, 40).

Before an action begins, the user can use an actuating mechanism, such as a press button, a sound/voice, a gesture and so on, to inform the exercise learning system 100 to start receiving the sensing data S of the sensor by way of wireless communication.

Another method obtains the initial position of each exercise sensor in the space by applying the distance and related angles that are measured with an infrared light or a laser light to the equations of the law of cosines. Referring to FIG. 3. Suppose the user respectively wears a sensor on his/her vertex, shoulder and sole, h denotes the user height, c1 denotes the distance from the vertex to the shoulder, c2 denotes the distance from the shoulder to the sole, h=c1+c2, distances d1˜d3 respectively denote the distances from the sensor disposed on the vertex, the shoulder and the sole to a fixed point S and can be obtained with an infrared light or a laser light, θ denotes an angle formed at a fixed point P with respect to the vertex and the sole, and θ=θ1+θ2. The following equations are obtained according to the law of cosines:

$${h}^{2} = {d}_{1}^{2} + {d}_{3}^{2} - 2 \cdot {d}_{1} {d}_{3} \cdot cos θ$$

$$θ = {cos}^{- 1} ( \frac{{d}_{1}^{2} + {d}_{3}^{2} - {h}^{2}}{2 \cdot {d}_{1} {d}_{3}} )$$

$$\{ \begin{matrix}{c}_{1}^{2} = {d}_{1}^{2} + {d}_{2}^{2} - 2 \cdot {d}_{1} {d}_{2} \cdot cos {θ}_{1} \\ {c}_{2}^{2} = {d}_{2}^{2} + {d}_{3}^{2} - 2 \cdot {d}_{2} {d}_{3} \cdot cos {θ}_{2}\end{matrix} \\ {c}_{2} = h - {c}_{1} , {θ}_{2} = θ - {θ}_{1} \\ ⇒ {( h - {c}_{1} )}^{2} = {d}_{2}^{2} + {d}_{3}^{2} - 2 \cdot {d}_{2} {d}_{3} \cdot cos ( θ - {θ}_{1} )$$

For example, suppose the user's height h is 160 cm, the distance d1 from the vertex sensor to the fixed point P is 208.8 cm, the distance d2 from the shoulder sensor to the fixed point P is 203 cm, and the distance d3 from the sole sensor to the fixed point P is 223.6 cm, then the following equations are obtained:

$${h}^{2} = {d}_{1}^{2} + {d}_{3}^{2} - 2 \cdot {d}_{1} {d}_{3} \cdot cos θ$$

$${160}^{2} = {208.8}^{2} + {223.6}^{2} - 2 \cdot 208.8 \cdot 223.6 \cdot cos θ$$

$$θ = 43.27 °$$

$$\{ \begin{matrix}{c}_{1}^{2} = {208.8}^{2} + {203}^{2} - 2 \cdot 208.8 \cdot 203 \cdot cos {θ}_{1} \\ {( 160 - {c}_{1} )}^{2} = {203}^{3} + {223.6}^{2} = 2 \cdot 203 \cdot 223.6 \cdot cos ( 43.27 - {θ}_{1} )\end{matrix} \\ ⇒ {c}_{1} = 25 , {θ}_{1} = 6.78 ° \\ {c}_{2} = h - {c}_{1} = 160 - 25 = 135 \\ {θ}_{2} = θ - {θ}_{1} = 43.27 - 6.78 = 36.49 °$$

It can be obtained that the initial height of the sensor disposed on the user's shoulder is 135 cm.

The first synchronous operation unit 103 synchronizes the sensing data of the several sensors disposed on the user's body. Suppose the user wears m sensors on his/her body. When the tick values of the first sampling data of the m sensors are recorded as: {t_{1,1}, t_{1,2}, t_{1,m}}, the tick values of the sensing data of a plurality of exercise sensors are recorded as: {(T_{i,j}−t_{1,j})*sⱼ|j=1 . . . m, i: time, s:1/number of sampling per second}.

Suppose the sensing data S is an acceleration data after the initial position of each sensor is obtained, then the action decomposition unit 106 can obtain the velocity data by integrating the acceleration value. Afterwards, a shift data is obtained by integrating the velocity data. For example, the integral is expressed as formula (1), the shift of each sensor on each of the X, Y, Z axes can be obtained with reference to the initial position of each sensor, and the position data of each sensor can further be obtained for generating an exercise trace corresponding to the exercise state of the user. Wherein, designation a denotes acceleration value, v denotes velocity value, and s denotes shift.

\vec{s}=∫\vec{v}·dt=∫(∫\vec{a}·dt)dt Formula (1)

The action decomposition unit 106 can also obtains the characteristic parameters of an exercise trace for processing exercise trace by the spherical-harmonic function. The spherical-harmonic function has three important features, namely, distinguishability (the result of encoding data by the spherical-harmonic function varies with data), stability (the result of encoding data can hardly be affected by noises), and invariance (the result of encoding remains the same for the same data despite the sampling methods being different). Therefore, it is very suitable to describe the action trace with the characteristic parameters obtained by the spherical-harmonic function. The method for obtaining the characteristic parameters by the spherical-harmonic function is disclosed below.

Let f (r,θ,φ) be a solution (sampling points) to the Laplace's equation in the spherical coordinate system, and satisfy:

$${∇}^{2} f = \frac{1}{{r}^{2}} \frac{\partial }{\partial r} ( {r}^{2} \frac{\partial f}{\partial r} ) + \frac{1}{{r}^{2} sin θ} \frac{\partial }{\partial θ} ( sin θ \frac{\partial f}{\partial θ} ) + \frac{1}{{r}^{2} {sin}^{2} θ} \frac{{\partial }^{2} f}{\partial {ϕ}^{2}} = 0$$

$$r = \sqrt{{x}^{2} + {y}^{2} + {z}^{2}}$$

Wherein, the designation r denotes the distance from f to the original point, θ denotes an angle between f and the z-axis, and φ denotes an angle between f and the x-axis:

$$θ = {cos}^{- 1} ( \frac{z}{r} ) , 0 \leq θ \leq π$$

$$ϕ = {tan}^{- 1} ( \frac{y}{x} ) , 0 \leq ϕ < 2 π$$

The sampling point f (r, θ, φ) can be expressed by the orthogonal basis function (referred as the spherical-harmonic function Y, the order is m, and the degree is I) as:

$$f ( r , θ , φ ) = {\sum }_{𝓁 = 0}^{∞} {\sum }_{m = - 𝓁}^{𝓁} a ( r ) \cdot {Y}_{𝓁}^{m} ( θ , φ )$$

$$Wherein , \\ a ( r ) = {p}_{lm} \cdot {r}^{l} + \frac{{q}_{lm}}{{r}^{l + 1}}$$

$${Y}_{𝓁}^{m} ( θ , φ ) = \sqrt{\frac{2 𝓁 + 1}{4 π} \frac{( 𝓁 - m ) !}{( 𝓁 + m ) !}} {P}_{𝓁}^{m} ( cos θ ) {e}^{i m φ}$$

$${P}_{𝓁}^{m} ( x ) = \frac{{( - 1 )}^{m}}{{2}^{𝓁} 𝓁 !} {( 1 - {x}^{2} )}^{m / 2} \frac{{d}^{𝓁 + m}}{d {x}^{𝓁 + m}} {( {x}^{2} - 1 )}^{𝓁}$$

the designation P denotes an associated Legendre polynomial, e denotes an exponential, and i denotes a dummy unit.

Since an action trace may include several sampling points f₁, f₂ . . . fₙ, the relationship between the data of one dimension can be expressed in a matrix below:

$$[ \begin{matrix}{y}_{1 , 1} & {y}_{1 , 2} & … & {y}_{1 , k} \\ {y}_{2 , 1} & {y}_{2 , 2} & … & {y}_{2 , k} \\ ⋮ & ⋮ & & ⋮ \\ {y}_{n , 1} & {y}_{n , 2} & … & {y}_{n , k}\end{matrix} ] [ \begin{matrix}{\tilde{a}}_{1} \\ {\tilde{a}}_{2} \\ ⋮ \\ {\tilde{a}}_{k}\end{matrix} ] = [ \begin{matrix}{f}_{1} \\ {f}_{2} \\ ⋮ \\ {f}_{n}\end{matrix} ]$$

$${y}_{i , j} = {Y}_{𝓁}^{m} ( {θ}_{i} , {φ}_{i} )$$

A set of fixed orthogonal basis function ãⱼ=aₗ^{m} can be selected as the characteristic parameters of the action trace in the current dimension. The action decomposition unit 106 processes the action trace according to the characteristic parameters. For example, the action decomposition unit 106 decomposes the exercise trace.

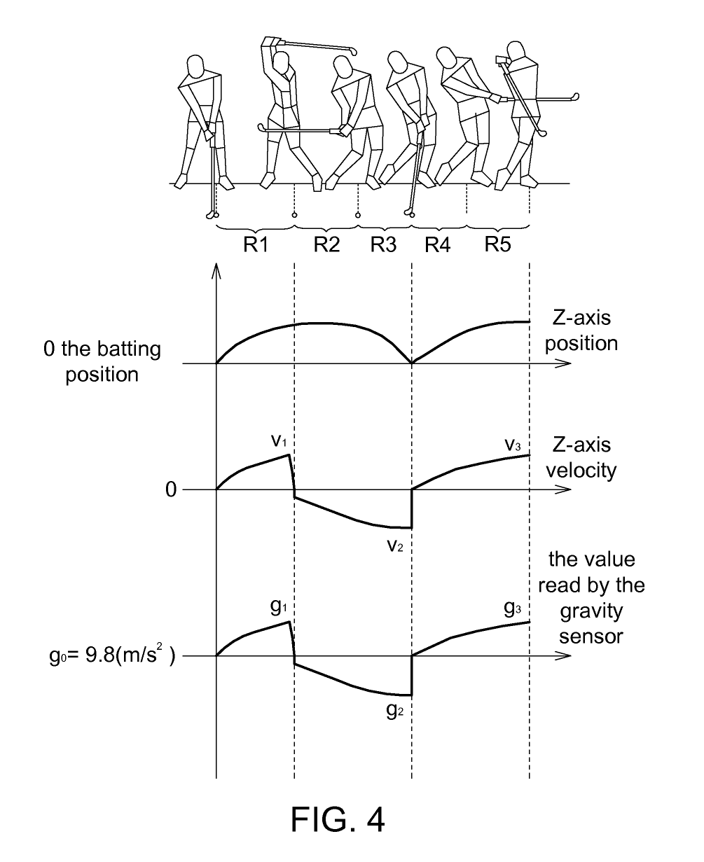

The action decomposition unit 106 such as decomposes the exercise trace according to the definition of the critical action. The definition of critical action is exemplified below with Golf exercise. Suppose the action of swing in Golf can be decomposed into back swing R1, early forward swing R2, acceleration R3, early follow through R4 and late follow through R5. Referring to FIG. 4, an example of corresponding trace direction of decomposed actions including back swing R1, early forward swing R2, acceleration R3, early follow through R4 and late follow through R5 in the course of a swing action in Golf is shown. The vertical axis is positive when moving downwards. Designation p1 denotes the batting point, p2 denotes the top of back swing, p3 denotes the batting point, and p4 denotes the end of the swing. Suppose the critical actions of swing in Golf include back swing R1, early forward swing R2, acceleration R3, early follow through R4 and late follow through R5 which are defined as follows:

Back swing R1: exercise trace moves from the lie to the top of back swing position. In the course of back swing R1, the absolute value of exercise velocity along the Z-axis increases to v₁ form 0 and then progressively decreases to 0, and the absolute value read by the gravity sensor increases to g₁ from g₀ and then progressively decreases to g₀.

Early forward swing R2: the shaft moves downwards and starts from the top of back swing until the shaft is parallel to the ground, and the exercise trace is about the first half of the trace from the top of back swing to the batting point.

Acceleration R3: the shaft moves to the batting point from a horizontal position, and the exercise trace is about the second half of the trace from the top of back swing to the batting point. When the acceleration R3 and the early forward swing R2 are combined together and viewed as one period, it can be seen that the absolute value of exercise velocity along the Z-axis increases to v₂ from 0, and the absolute value read by the gravity sensor increases to g₂ from g₀ and then progressively decreases to g₀.

Early follow through R4: the shaft moves to a horizontal position from the impact, and the exercise trace is about a first half of the trace from the batting point to the pars vertex.

Late follow through R5: the shaft moves to the end of the swing from the horizontal position, and the exercise trace is about the second half of the trace from the batting point to the pars vertex. When the late follow through R5 and the early follow through R4 are combined together and viewed as one period, it can be seen that the absolute value of exercise velocity along the Z-axis increase to v₃ from 0, and the absolute value read by the gravity sensor increases to g₃ from g₀.

Based on the sensing data and the exercise trace, the starting point and the end point for each of the user's critical actions can be determined, and the data for each critical action data (such as the space coordinates of several sampling points in the exercise trace of each critical action) can be obtained.

Referring to FIG. 4, an example of the experimental results of corresponding position in the space, corresponding velocity and corresponding acceleration of gravity for each critical action in the course of a swing action in Golf is shown. The starting point and the end point for each of the critical actions such as back swing R1, early forward swing R2, acceleration R3, early follow through R4 and late follow through R5 can be located by calculating the sensing data and the exercise trace obtained by the sensors with reference to possible velocity and acceleration value for each critical action of FIG. 4. The action decomposition unit 106 such as decomposes the exercise trace according to the above definitions of critical actions to generate at least one critical action data. For the second synchronous operation unit 108, if the coach's action velocity is inconsistent with the user's velocity, then the sampling number of the coach's critical action data may be different from that of the user's critical action data, and comparison would become difficult. To sequentially compare two sets of critical action data whose sampling numbers are different, the sampling numbers can be made consistent by way of interpolation.

For the body proportion adjustment unit 110, the user's action trace may be different the coach's due to the difference in the builds or the limb lengths, and action comparison will thus become difficult. To fix such problem, a group of parameters (wₓ(x),w_{y}(_{Y), w}_{z}(z)) is employed to adjust the errors which occur due to different body builds or limb length or position between the coach and the user.

$$\{ \begin{matrix}{w}_{x} ( x ) = f ( x ) = {a}_{1} x + {b}_{1} \\ {w}_{y} ( y ) = f ( y ) = {a}_{2} y + {b}_{2} \\ {w}_{z} ( z ) = f ( z ) = {a}_{3} z + {b}_{3}\end{matrix}$$

In the above equations, the parameters a₁·a₃, and b₁˜b₃ can be obtained by the least squared error method by applying the coordinates of the user's sensor position to the x, y, and z of the above equations and applying the coordinates of the coach's sensor position to wₓ(x), w_{y}(y), and w_{z}(z) of the above equations, wherein the above coordinates are already known. After applying the coordinates (x, y, z) of the user's exercise trace to the above equations, the adjusted coordinates (wₓ(x),w_{y}(y),w_{z}(z)) of the user's exercise trace is obtained. By doing so, the proportion of limb is adjusted and comparison error will thus be deceased.

The action segment comparison unit 112 describes the coach's exercise sensing data and the characteristic values of a 3-D exercise trace as (a_{e,x,i}a_{e,y,i}a_{e,z,i}), and describes the user's exercise sensing data and an exercise trace as (a_{l,x,i}a_{l,y.i},a_{l,z,i}). The definition of similarity is exemplified below:

$$Sim ( {a}_{e} , {a}_{l} ) = 1 - \frac{{\sum }_{i = 0}^{n - 1} [ \vert {a}_{l , x , i} - {a}_{e , x , i} \vert + \vert {a}_{l , y , i} - {a}_{e , y , i} \vert + \vert {a}_{l , z , i} - {a}_{e , z , i} \vert ]}{{\sum }_{i = 0}^{n - 1} {a}_{l , x , i} + {a}_{l , y , i} + {a}_{l , z , i}}$$

Wherein, the normalized similarity will range between 0%˜100%.

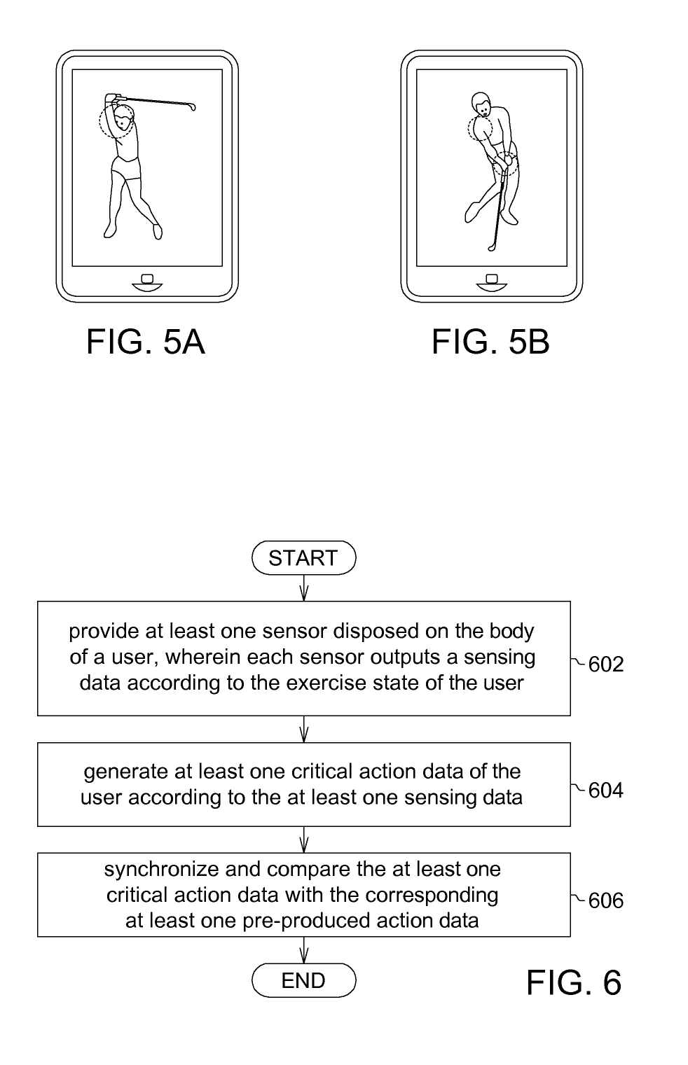

For the erroneous action display unit 114, when the similarity is smaller than a particular threshold, this implies that the user may have error in a particular action of a series of continuous actions. Meanwhile, the erroneous action display unit 114 will output a signal such as a warning sound/voice or image to inform the user, and further replay and mark the erroneous actions and suggested adjustment with the accompany of a pre-produced teaching film of coach's exercise action image as indicated in FIG. 5A and FIG. 5B. The third synchronous operation unit 113 synchronizes and compares the sensing data of at least one critical action with the image data of the corresponding at least one pre-produced action. The above synchronization and comparison can be implemented by recording the tick value at which error occurs to the user action, and locate and play the segment of the coach's teaching film corresponding to the same tick. Or, after the user's critical action (such as “forward swing” or “acceleration”) is determined, the segment of the teaching film corresponding to the coach's demonstration of the said critical action (such as “forward swing” as indicated in FIG. 5A or “acceleration” as indicated in FIG. 5B) is replayed for the user to view and imitate again.

The sensing unit 102 and the processing module 104 can be separately disposed. The sensing unit 102 transmits the sensing data of several sensors to the processing module 104 by way of wireless communication. The processing module 104 can be disposed at a local end or a remote end computing device. The exercise action image and exercise sensing data of the coach can be pre-recorded or filed and stored in the local end or remote end computing device.

The present embodiment of the disclosure further provides a method for assisting the user in exercise learning as indicated in the flowchart of FIG. 6. In step 602, at least one sensor disposed on the body of a user is provided, wherein each sensor outputs a sensing data according to the exercise state of the user. In step 604, at least one critical action data of the user is generated according to the at least one sensing data. In step 606, the at least one critical action data and the corresponding at least one pre-produced action data are synchronized and compared with each other.

The exercise learning system and the method for assisting the user in exercise learning disclosed in the present embodiment of the disclosure help the user to learn how to do exercise more correctly, so that the user can achieve excellent learning results and become more willing and proactive to do exercise. Consequently, the user's health can thus be improved.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An exercise learning system, comprising:
a sensing unit comprising at least one sensor used for being disposed on the body of a user, wherein each at least one sensor further outputs at least one sensing data according to the exercise state of the user; and
a processing module used for receiving the at least one sensing data and generating at least one critical action data according to the at least one sensing data, wherein the processing module further synchronizes and compares the at least one critical action data with the corresponding at least one pre-produced action data.

2. The system according to claim 1, further comprising a pre-produced action data storage unit used for recording the pre-produced action data correlated with an exercise action image and an exercise sensing data.

3. The system according to claim 1, wherein the at least one sensor comprises at least one of a gravity sensor, an angular velocity meter, and a magnetometer.

4. The system according to claim 1, wherein the at least one pre-produced action data is correlated with a coach's' exercise action image exercise sensing data.

5. The system according to claim 1, wherein the pre-produced action data is correlated with a learner's own previous exercise action image and exercise sensing data.

6. The system according to claim 1, wherein the at least one sensor comprises a plurality of sensors, and the processing module comprises:
an action decomposition unit used for generating an exercise trace corresponding to the exercise state of the user according to the at least one sensing data, and decomposing the exercise trace to generate the at least one critical action data;
a first synchronous operation unit used for synchronizing the sensing data of the sensors disposed on the user; and
a second synchronous operation unit used for synchronizing and comparing the sensing data of the at least one critical action with the sensing data of the corresponding at least one pre-produced action.

7. The system according to claim 6, wherein the processing module further comprises:
a third synchronous operation unit used for synchronizing and comparing the sensing data of the at least one critical action with the image data of the corresponding at least one pre-produced action.

8. The system according to claim 6, wherein the action decomposition unit decomposes the exercise trace according to the definition of the critical action.

9. The system according to claim 6, wherein the action decomposition unit obtains the characteristic parameters of the exercise trace for processing exercise trace by the spherical-harmonic function.

10. The system according to claim 6, wherein the at least one pre-produced action data corresponds to a coach's demonstration, and the processing module further comprises:
a body proportion adjustment unit used for adjusting at least one of the at least one critical action data and the at least one pre-produced action data according to the difference between the user's body builds and the coach's body builds.

11. The system according to claim 6, wherein the processing module further comprises:
an action segment comparison unit used for comparing the similarity between the at least one critical action data and the corresponding pre-produced action data; and
an erroneous action display unit used for replaying a teaching film corresponding to the pre-produced action data when the similarity between one of the at least one critical action data and the corresponding pre-produced action data is smaller than a threshold.

12. The system according to claim 1, wherein the sensing unit transmits the at least one sensing data to the processing module by way of wireless communication, and the processing module is disposed in a local end or remote end computing device.

13. A method for assisting the user in exercise learning, comprising:
providing at least one sensor disposed on the body of a user, wherein each sensor outputs a sensing data according to the exercise state of the user;
generating at least one critical action data of the user according to the at least one sensing data; and
synchronizing and comparing the at least one critical action data with the corresponding at least one pre-produced action data.

14. The method according to claim 13, further comprising the pre-produced exercise action image and the exercise sensing data of a coach or a learner.

15. The method according to claim 13, wherein each at least one sensor comprises at least one of a gravity sensor, an angular velocity meter, and a magnetometer.

16. The method according to claim 14, wherein, the pre-produced exercise action image and exercise sensing data are recorded in a mapping table which is independent from an electronic file of the exercise action image, or the mapping table and the exercise action image are recorded in a video image file at the same time.

17. The method according to claim 13, wherein, the at least one sensor comprises a plurality of sensors, and the method further comprises:
synchronizing the sensing data of the sensors disposed on the user on the basis of the sampling time data and the sampling rate.

18. The method according to claim 13, wherein the step of detecting at least one critical action data of the user comprises:
generating an exercise trace corresponding to the exercise state of the user according to the at least one sensing data; and
decomposing the exercise trace to generate the at least one critical action data.

19. The method according to claim 18, wherein in the decomposition step, the exercise trace is decomposed according to the definition of the critical action.

20. The method according to claim 18, wherein in the step of decomposing the exercise trace, the characteristic parameters of the exercise trace are obtained for processing exercise trace by the spherical-harmonic function.

21. The method according to claim 13, wherein the at least one pre-produced action data corresponds to a coach's demonstration, and the method further comprises:
adjusting at least one of the at least one critical action data and the at least one pre-produced action data according to the difference between the user's body builds and the coach's body builds.

22. The method according to claim 13, wherein the method further comprises:
comparing the similarity between the at least one critical action data and the corresponding pre-produced action data; and
replaying a teaching film corresponding to the pre-produced action data when the similarity between one of the at least one critical action data and the corresponding pre-produced action data is smaller than a threshold.

23. The method according to claim 13, wherein the sensing unit transmits the at least one sensing data to the processing module by way of wireless communication, and the processing module is disposed in a local end or remote end computing device.
